(19) United States
(12) Patent Application Publication
(10) Pub. No.: US 2006/0103721 A1
(43) Pub. Date: May 18, 2006

(54) Video conference system utilizing a mobile phone and method thereof

(76) Inventors: Chien-Chung Shih, Changhua City (TW); Wei-Wen Yu, Keelung City (TW)

Correspondence Address: RABIN & Berdo, PC, 1101 14TH STREET, NW, SUITE 500, WASHINGTON, DC, 20005, US

(21) Appl. No.: 11/267,139

(22) Filed: Nov. 7, 2005

(30) Foreign Application Priority Data
Nov. 12, 2004 (TW) 93134831

(51) Int. Cl. H04N 7/14

(52) U.S. Cl. 348/14.01; 455/566

(57) ABSTRACT

A video conference system utilizing a mobile phone and the method thereof is provided. The video conference system includes a computer host, a mobile phone, a computer monitor, and an internet. The mobile phone includes an audio detection device, a photo-sensing device, a conversion unit, a transceiver unit, and a loudspeaker. The mobile phone records images and sounds, and outputs a video signal and an audio signal to the computer host accordingly. The computer further sends the video and audio signals to a remote client via an internet. The images and sounds in the remote client are sent to the computer host via the internet, and the sounds are played out by the loudspeaker of the mobile phone.

This application claims the benefit of Taiwan application Serial No. 93134831, filed Nov. 12, 2004, the subject matter of which is incorporated herein by reference.

### BACKGROUND OF THE INVENTION

1. Field of the Invention

The invention relates in general to a video conference system and method thereof, and more particularly to a video conference system utilizing a mobile phone and method thereof.

2. Description of the Related Art

The progressing internet has popularized the instant message software, such as MSN, ICQ, or the like, through which users can communicate with each other remotely without the limitation of distance. In the early stage, the instant message software only provides the text communication. With the increase of the internet bandwidth and the progress of the video/audio compression technology, the instant message software may also provide the audio and video transmission such that remote video conference may be implemented.

FIG. 4 shows a conventional video conference system. Referring to FIG. 4, the conventional video conference system includes a computer host 420, a computer monitor 422, an internet video recorder 410, a microphone 412 and a loudspeaker 414. The video/audio transmission between users can be performed through an internet 430. The internet video recorder 410 records the image VI of a local user. The microphone 412 captures the sound AI of the local user. A computer 420 assembles the video VI and audio AI into a packet DO and transmits the packet DO to the internet 430. The computer 420 receives the video and audio packet DI of the remote user through the internet 430, regains the image VO from the packet Dl displays the image VO on the computer monitor and broadcasts the sound AO by the loudspeaker 414.

However, the conventional video conference system needs too many peripheral devices, and the number of connection wires is too large such that the preparing procedure is very inconvenient, and the using procedure tends to distract the concentration owing to the large number of the peripheral devices.

### SUMMARY OF THE INVENTION

It is therefore an object of the invention to provide a video conference system utilizing a mobile phone, wherein the system can effectively solve the problem of too many peripheral devices needed in the conventional video conference system.

The invention achieves the above-identified object by providing a mobile phone adapted to a video conference system, which comprises a computer host and a computer monitor. The mobile phone includes an audio detection device, a photo-sensing device, a conversion unit, a transceiver unit and a loudspeaker. The photo-sensing device records images and outputs a first video signal. The audio detection device records voice and outputs a first audio signal. The conversion unit receives the first video signal and the first audio signal and outputs a first packet accordingly. The transceiver unit receives and converts the first packet into a first signal and outputs the first signal to the computer host. The computer host receives the first signal, and then regains the first video signal and the first audio signal from the first signal. The first audio signal is played out by the loudspeaker, and the first video signal is played out by the computer monitor. The computer host connected to an internet generates a first network packet to be sent to the internet according to the first video signal and the first audio signal. A second network packet is sent to the computer host through the internet. Then, the computer host regains the second video signal and the second audio signal from the second network packet, and generates and outputs a second signal to the transceiver unit according to the second audio signal. The transceiver unit receives the second signal, converts the second signal into a second packet, and forwards the second packet to the conversion unit. Next, the conversion unit receives and regains the second audio signal from the second packet. The loudspeaker plays out the second audio signal transmitted from the conversion unit.

The invention also achieves the above-identified object by providing a video conferencing method utilizing a mobile phone in a video conference system. The mobile phone includes a photo-sensing device, an audio detection device, a conversion unit, a transceiver unit and a loudspeaker. The photo-sensing device outputs a first video signal, and the audio detection device outputs a first audio signal. The conversion unit receives the first video signal and the first audio signal, and generates a first packet according to the two received signals. The transceiver unit converts the first packet into a first signal and then outputs the first signal. A computer host regains the first video signal and the first audio signal from the received first signal. Then, the computer host plays out the first video signal and generates a first network packet to be sent to an internet according to the first video signal and the first audio signal. The computer host receives a second network packet through the internet and regains a second video signal and a second audio signal from the second network packet. The computer host converts the received second audio signal into a second signal and outputs the second signal. The transceiver unit receives the second signal and converts the second signal into a second packet, and forwards the second packet to the conversion unit. The conversion unit regains the second audio signal from the second packet and the loudspeaker plays the second audio signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a video conference system according to a preferred embodiment of the invention.

FIGS. 2 and 3 are flow charts showing steps performed in the video conference system according to the preferred embodiment of the invention.

FIG. 4 shows a conventional video conference system.

### DETAILED DESCRIPTION OF THE INVENTION

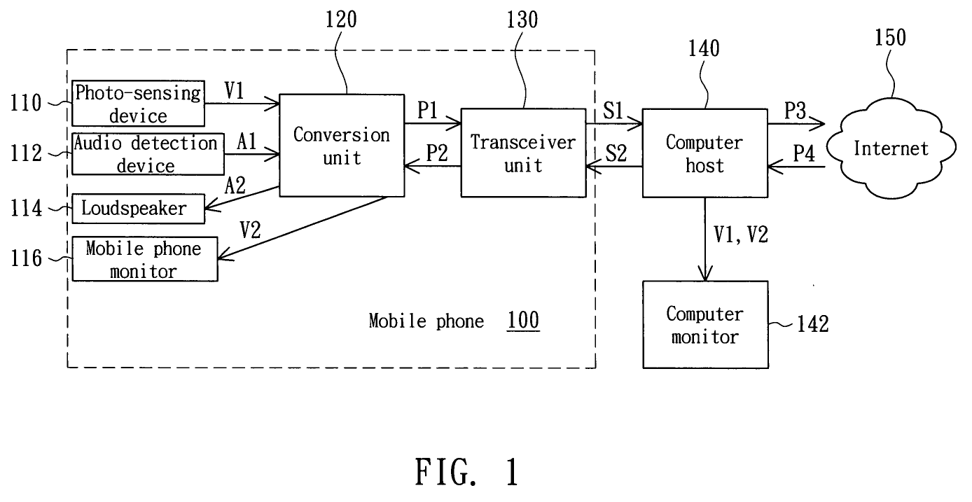

FIG. 1 shows a video conference system according to a preferred embodiment of the invention. The video conference system includes a computer host 140, a computer monitor 142, a mobile phone 100 and an internet 150. The computer host 140 may communicate with the mobile phone 100 through a USB interface, a 1394 interface, or a radio interface such as an infrared interface or a bluetooth interface.

The computer host 140 is further connected to the internet 150 in order to communicate with a remote client. The computer monitor 142, which is connected to the computer host 140, plays out the video signals V1 and V2 transferred from the mobile phone 100 and the internet 150.

The mobile phone 100 includes a photo-sensing device 110, an audio detection device 112, a loudspeaker 114, a mobile phone monitor 116, a conversion unit 120 and a transceiver unit 130. The mobile phone 100 has a communication mode and a video-recording mode. In the video-recording mode, the mobile phone 100 may serve as a camera or a video recorder to capture static or dynamic images, or serve as a video recorder to capture the dynamic images in the video conferencing procedure.

When the mobile phone 100 serves as the video recorder, the photo-sensing device 110 using the charge coupled device (CCD) or the complementary metal oxide semiconductor (CMOS) device, for example, receives the user's image and outputs a video signal V1. The audio detection device 112, such as a microphone, receives the user's voice, and outputs an audio signal A1. The conversion unit 120 connected with the photo-sensing device 110 and the audio detection device 112 respectively, receives the video signal V1 and the audio signal A1 and converts them into a packet P1. Then, the transceiver unit 130 connected with the conversion unit 120 and the computer host 140 respectively, converts the packet P1 into a first signal S1 to be outputted to the computer host 140. The transceiver unit 130 may have the USB interface, the 1394 interface or the radio interface such as the infrared interface, the fast infrared (FIR) interface or the bluetooth interface to communicate with the computer host 140.

Next, the computer host 140 receives the first signal S1 and then regains the video signal V1 and the audio signal A1 from the first signal S1. The computer host 140 selectively plays out the video signal V1 on the computer monitor 142, generates a network packet P3 according to the video signal V1 and the audio signal A1, and then forwards the network packet P3 to a remote client of the video conference through the internet 150.

The computer host 140 receives a network packet P4 sent from the internet 150, regains a video signal V2 and an audio signal A2 from the network packet P4, and selectively displays the video signal V2 on the computer monitor 142, and converts the audio signal A2 into a second signal S2, which is to be forwarded to the transceiver unit 130. The transceiver unit 130 forwards a packet P2 composed of the second signal S2 to the conversion unit 120. The conversion unit 120 regains the audio signal A2 from the packet P2. Finally, the loudspeaker 114 plays out the audio signal A2.

This embodiment utilizes the computer monitor 142 to display the video signal V2 from the remote client. In addition, it is also possible to display the video signal V2 on the mobile phone monitor 116, and detailed descriptions thereof will be omitted.

In addition, when the mobile phone 100 is utilized to perform the video conference and a call comes, the mobile phone 100 may also selectively leave the video-recording mode and enter the communication mode to answer the call.

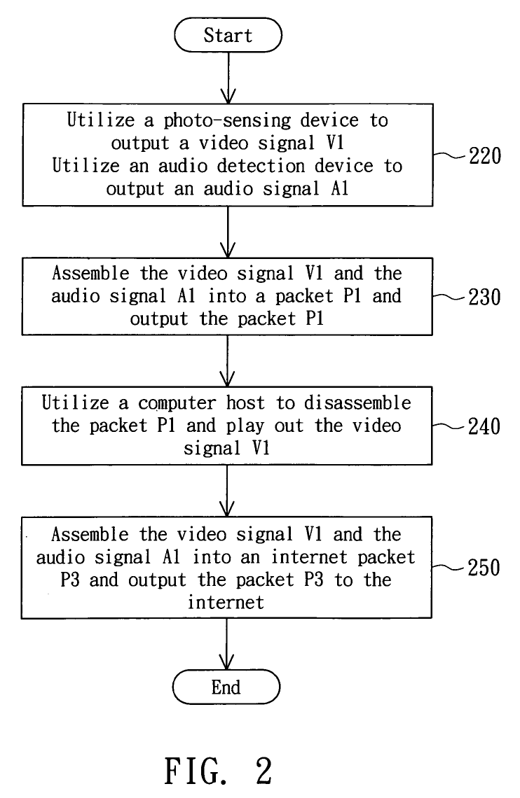

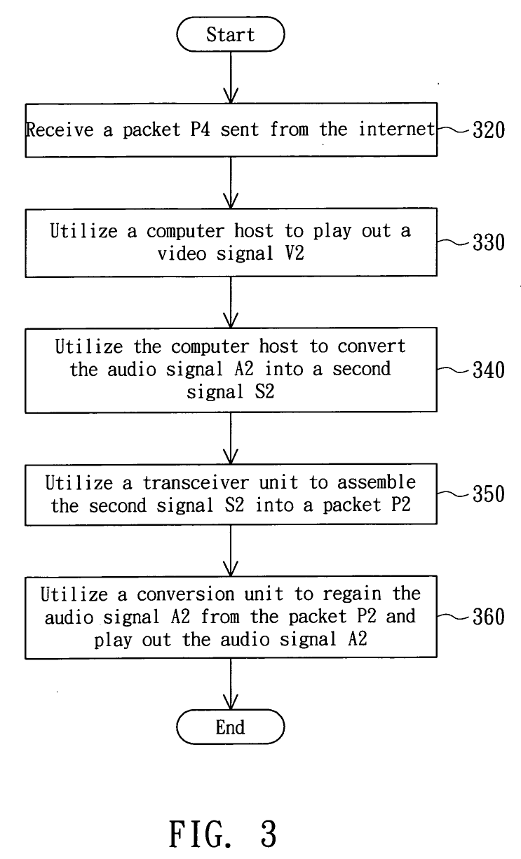

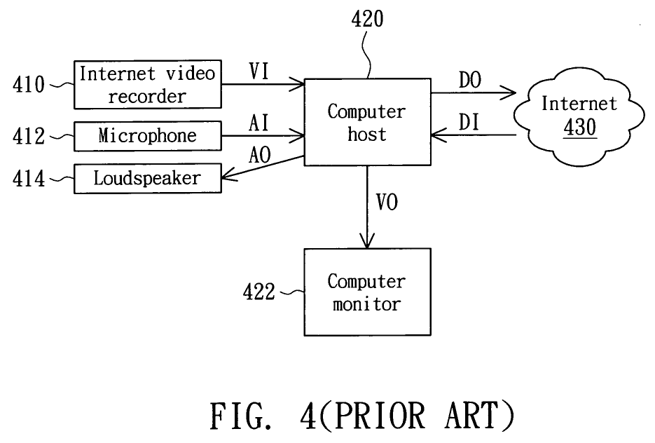

FIGS. 2 and 3 are flow charts showing steps performed in the video conference system according to the preferred embodiment of the invention. FIG. 2 is the flow chart showing the method for outputting video/audio signals from the local user. First, the photo-sensing device 110 of the mobile phone 100 is utilized to receive the user's image and output the video signal V1 while the audio detection device 112 is utilized to receive the user's voice and output the audio signal A1, as shown in step 220. Next, in step 230, the conversion unit 120 is utilized to receive the video signal V1 and the audio signal A1 and convert the video signal V1 and the audio signal A1 into the packet P1. Then, the transceiver unit 130 is utilized to convert the packet P1 into the first signal S1 and output the first signal S1 to the computer host 140. In step 240, the computer host 140 is utilized to regain the video signal V1 and the audio signal A1 from the packet P1, and selectively play out the video signal V1 on the computer monitor 142. Next, in step 250, the computer host 140 is utilized to generate the network packet P3 according to the video signal V1 and the audio signal A1, and then the network packet P3 is forwarded to the remote client of the video conference through the internet 150.

FIG. 3 is a flow chart showing a method for receiving video/audio signal from the remote client. First, in step 320, the computer host 140 is utilized to receive the network packet P4 sent from the internet 150. In step 330, the computer host 140 is utilized to regain the video signal V2 and the audio signal A2 from the network packet P4, and then display the video signal V2 on the computer monitor 142. Next, in step 340, the computer host 140 is utilized to convert the audio signal A2 into the second signal S2, and forward the second signal S2 to the transceiver unit 130. Then, in step 350, the transceiver unit 130 is utilized to assemble the second signal S2 into the packet P2 and forward the packet P2 to the conversion unit 120. Next, in step 360, the conversion unit 120 of the mobile phone 100 is utilized to regain the audio signal A2 from the packet P2, and the loudspeaker 114 is utilized to play out the audio signal A2.

The video conference system according to the embodiment of the invention has the following advantages. First, the number of peripheral elements required in the video conference system can be reduced. In the conventional video conference system, because there are too many peripheral devices, it will take more time for preparation and the user has to pay more attention to set up the whole system. The invention utilizes the mobile phone to achieve the functions of three conventional peripheral devices including the internet video recorder, the speaker, and the microphone, so the number of peripheral devices can be reduced, and the user may use the video conference system more conveniently. In addition, the mobile phone can further communicate with the computer host in a wireless manner, so the number of connection wires can be further reduced.

Second, the cost of building the video conference system can be reduced. Because the current mobile phone has the function of video recording, the user does not have to additionally purchase the peripheral devices such as the internet video recorder when he or she wants to use the video conference system of the invention. Thus, the purchasing cost may also be reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mobile phone, having a communication mode and a video-recording mode, the mobile phone adapted to a video conference system, the conference system comprising a computer host and a computer monitor, the mobile phone comprising:
a photo-sensing device for recording images and outputting a first video signal;
an audio detection device for recording sounds and outputting a first audio signal;
a conversion unit connected with the photo-sensing device and the audio detection device respectively, for receiving the first video signal and the first audio signal and outputting a first packet accordingly;
a transceiver unit connected with the conversion unit and the computer host respectively, for receiving and converting the first packet into a first signal and outputting the first signal to the computer host; and
a loudspeaker connected with the conversion unit;
wherein the computer host regains the first video signal and the first audio signal from the first signal received via the transceiver unit, plays out the first video signal and the first audio signal, and generates and outputs a first network packet to an internet according to the first video signal and the first audio signal;
wherein the computer host regains a second video signal and a second audio signal from a second network packet received via the internet, and generates and outputs a second signal according to the second audio signal;
wherein the transceiver unit receives the second signal, then converts the second signal into a second packet, and forwards the second packet to the conversion unit;
wherein the conversion unit receives the second packet and regains the second audio signal from the second packet, and outputs to the loudspeaker for play.

2. The mobile phone according to claim 1, wherein the mobile phone leaves the video-recording mode and enters the communication mode when the mobile phone receives a call.

3. The mobile phone according to claim 1, wherein the transceiver unit communicates with the computer host through a USB interface, a 1394 interface, an infrared interface or a bluetooth interface.

4. The mobile phone according to claim 1, wherein the photo-sensing device is a charge coupled device (CCD) or a complementary metal oxide semiconductor (CMOS) device.

5. The mobile phone according to claim 1, wherein the computer host generates the second signal according to the second audio signal and the second video signal.

6. The mobile phone according to claim 1, wherein the second video signal is displayed on the computer monitor.

7. The mobile phone according to claim 1, further comprising a mobile phone monitor, wherein the second video signal is selectively displayed on the mobile phone monitor and/or the computer monitor.

8. A video conference system, comprising:
a computer host, having a computer monitor; and
a mobile phone, having a communication mode and a video-recording mode, capable of communicating with the computer host, the mobile phone comprising:
a photo-sensing device, for recording images and outputting a first video signal;
an audio detection device, for recording sounds and outputting a first audio signal;
a conversion unit connected with the photo-sensing device and the audio detection device respectively, for receiving the first video signal and the first audio signal and outputting a first packet accordingly;
a transceiver unit connected with the conversion unit and the computer host respectively, for receiving and converting the first packet into a first signal, and outputting the first signal to the computer host; and
a loudspeaker connected with the conversion unit;
wherein the computer host regains the first video signal and the first audio signal from the first signal received via the transceiver unit, plays out the first video signal and the first audio signal, and generates and outputs a first network packet to an internet according to the first video signal and the first audio signal;
wherein the computer host regains a second video signal and a second audio signal from a second network packet via the internet, and generates and outputs a second signal according to the second audio signal;
wherein the transceiver unit receives the second signal, then converts the second signal into a second packet, and forwards the second packet to the conversion unit;
wherein the conversion unit receives the second packet and regains the second audio signal from the second packet and outputs to the loudspeaker for play.

9. The video conference system according to claim 8, wherein the mobile phone leaves the video-recording mode and enters the communication mode when the mobile phone receives a call.

10. The video conference system according to claim 8, wherein the transceiver unit communicates with the computer host through a USB interface, a 1394 interface, an infrared interface or a bluetooth interface.

11. The video conference system according to claim 8, wherein the photo-sensing device is a charge coupled device (CCD) or a complementary metal oxide semiconductor (CMOS) device.

12. The video conference system according to claim 8, wherein the computer host generates the second signal according to the second audio signal and the second video signal.

13. The video conference system according to claim 9, wherein the second video signal is displayed on the computer monitor.

14. The video conference system according to claim 9, wherein the mobile phone further comprises a mobile phone monitor, wherein the second video is selectively displayed on the mobile phone monitor and/or the computer monitor.

15. A video conferencing method, utilizing a mobile phone, a computer host and a computer monitor, the mobile phone comprising a photo-sensing device, an audio detection device, a conversion unit, a transceiver unit and a loudspeaker, the method comprising the steps of:
utilizing the photo-sensing device to output a first video signal;
utilizing the audio detection device to output a first audio signal;
utilizing the conversion unit to receive the first video signal and the first audio signal and to generate a first packet accordingly;
utilizing the transceiver unit to convert the first packet into a first signal and to output the first signal;
utilizing the computer host to receive the first signal, to regain the first video signal and the first audio signal from the first signal, to play out the first video signal, and to generate and output a first network packet to an internet according to the first video signal and the first audio signal;
utilizing the computer host to receive a second network packet from the internet, and to regain a second video signal and a second audio signal from the second network packet;
utilizing the computer host to generate and output a second signal according to the second audio signal;
utilizing the transceiver unit to receive the second signal, to convert the second signal into a second packet, and to forward the second packet to the conversion unit; and
utilizing the conversion unit to receive the second packet, to regain the second audio signal from the second packet, and to output the second audio signal to the loudspeaker for play.

16. The method according to claim 15, wherein the transceiver unit communicates with the computer host through a USB interface, a 1394 interface, an infrared interface or a bluetooth interface.

17. The method according to claim 15, wherein the computer host generates the second signal according to the second audio signal and the second video signal in the step of generating the second signal.

18. The method according to claim 15, wherein the mobile phone further comprises a mobile phone monitor, and the second video signal is selectively displayed on one of the mobile phone monitor and the computer monitor in the step of regaining the second audio signal from the second packet.
